(19) United States
(12) Patent Application Publication
(10) Pub. No.: US 2008/0071577 A1
(43) Pub. Date: Mar. 20, 2008

(54) Dual-access security system for medical records

(76) Inventor: Robert D. Highley, Kirkland, WA (US)

Correspondence Address: MERCHANT & GOULD PC, P.O. BOX 2903, MINNEAPOLIS, MN, 55402-0903, US

(21) Appl. No.: 11/522,093

(22) Filed: Sep. 14, 2006

(51) Int. Cl. H04L 9/32; G06F 19/00

(52) U.S. Cl. 705/3; 705/50; 726/2

(57) ABSTRACT

A secure system for accessing records uses a provider media device and a consumer media device to access records associated with the consumer. Both the consumer and provider media devices are normally authenticated before access to the consumer records is granted. Records can be centrally stored in a central location and downloaded, in full or in part, to the consumer media device. Passwords can be used to grant local access to consumer media device, for example, in the absence of network connectivity.

### BACKGROUND

Health care systems often exist independently and have been described as being “a confederation of cottage industries.” The population for which the health care systems exist is mobile and medical care is delivered episodically, often across disparate delivery systems (such as health care providers), which makes true continuity of care difficult to provide using conventional systems. Medical records are not always available at the point of care, even within a single delivery system. Medical records are usually not readily available for a given system when care was previously given outside that system. Additionally, medical records are usually never available for first line responders, especially in emergency situations.

Medical records are typically institutionally-based and are normally transferred between institutions in accordance with the restrictive HIPAA (Health Information Privacy and Accountability Act) mandates. Often parts of the record are missing and they have to be “reconstructed.” Reconstructed records often have significant gaps and merely filling in the blanks with the “most likely scenario” often creates errors, which can multiply such that telling and small errors can suddenly become potentially lethal errors. Thus, the conventional system all too often fragments medical data, which creates omissions and promulgates errors. The Institute of Medicine estimates that over 98,000 people die each year from medical errors and much of this could be prevented.

Recent public emergencies such as category 5 hurricanes and coordinated terror events have demonstrated the consequences of the failings of conventional systems due to, for example, severed communication lines and/or overloaded communication circuits.

### SUMMARY OF THE INVENTION

The present disclosure provides exemplary embodiments of the invention, which is defined by the claims as recited herein. In various embodiments, a medical record system is disclosed that robustly, timely, accurately, and securely delivers necessary medical records to arbitrary-but-authorized medical providers in an interoperative fashion, even during times of public disasters and emergencies. The medical record system would connect patients, providers, pharmacies, clinics, hospitals, payers, and producers through a secure private network that operates in real time and can operate without grid power or the Internet in case of man-made or natural disasters.

The medical record system provides a technology solution and business processes that can connect authorized parties in real time, with or without connectivity such as provided by the Internet. A method and apparatus for a global portable medical record system (GPMR) is disclosed that can provide universal connectivity with or without the Internet to concerned parties at arbitrary locations.

In an embodiment, a smart card provides a portable medium to carry medical emergency data on the card and provides security access to a virtual private network (VPN). The VPN provides secure encrypted data transmission among the “six P's” (Patients, Providers, Payers, Plans, Pharmacies and Producers). The VPN cannot normally be entered without a smart card issued by a certificate of authority. All exchanges of information can be tracked to insure patient privacy and HIPAA compliance. An ASP (active server pages) model can be used to deliver the contents of the medical record and connect the smart card records to the VPN and database servers to complete the system.

The medical record system can provide a longitudinal record of original data over time and across delivery systems. In operation, each institution records the current episode of care and adds that original data to an ongoing longitudinal record. The patient carries a smart card with core data for emergency use and a link (such as a URL) to the server where their entire medical record is housed. In this way, universal access is provided to an ultra secure, fully integrated, real time, portable medical record that aggregates original data over time and across delivery systems. Integration and connectivity will typically decrease medical errors, improve care and reduce costs. Additionally the smart cards can be configured to download pertinent information such as demographic information to any form or note within the ASP framework.

### BRIEF DESCRIPTION OF THE DRAWINGS

Non-limiting and non-exhaustive embodiments are described with reference to the following drawings.

FIG. 1 is a logic diagram illustrating a dual access security system for medical records.

### DETAILED DESCRIPTION

Various embodiments will be described in detail with reference to the drawings, where like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

Throughout the specification and claims, the following terms take at least the meanings explicitly associated herein, unless the context clearly dictates otherwise. The meanings identified below are not intended to limit the terms, but merely provide illustrative examples for use of the terms. The meaning of “a,” “an,” and “the” may include reference to both the singular and the plural. The meaning of “in” may include “in” and “on.” The term “coupled” can mean a direct connection between items, an indirect connection through one or more intermediaries, or communication between items in a manner that may not constitute a connection.

Global Portable Medical Record (GPMR) refers to a smart card microchip record that can contain, for example, more than 50 pages of core data (demographic data, contact information, allergies, insurance information, growth and development, social history, family history, list of medications, problem list, implantable devices, security preferences, HIPAA preferences, living will, birth certificate, and the like) that can be read directly from the card (when, for example the core medical record can only be accessed OFF-line.) When WAN or Internet connectivity can be established (e.g., when the core medical record is ON-line), a locator such as a URL code stored in the card can direct the user to the server where the complete medical record is stored. (Thus, the GPMR provides limited OFF-line access to core medical data stored on the card in any emergency where the Internet is not available. A URL link provides real-time ON-line medical records and such that concerned individuals can be connected through a secure network.)

Web record refers to the complete medical record (labs, X-rays, procedure notes, etc) stored on a server managed by a Clinical Information System (CIS) an accessed over the Internet, for example.

Clinical Information System (CIS) is a software application that enters, records, stores and retrieves records from a database repository. Well known systems are HBOC, OASIS, EPIC, Cerner, IDX/GE, PHAMIS, Last Word, and the like.

HIPAA—Health Information Privacy & Accountability Act is a set of Federal regulations that mandate limitations to health records and rules governing access to private medical records. The legislation indicates that the medical record belongs to the patient and access to their personal record can only be achieved with the permission and direction of the patient or their designated guardian. Thus the individual owns and controls the use of their personal record.

Dual Access Security (DAS) refers to a method for security access to medical records. To access a portable medical record requires (at least) two keys and two passwords to enter either the portable medical record or the web record. Accordingly, the patient normally needs to have physical possession of their GPMR (which contains at least one first key). The patient inserts (physically and/or logically) the GPMR (which is typically in the form of a CPU card such as a smart card) into a reader that has been issued and authenticated by the private network and gives permission to access the record by entering one of two pre-determined passwords (for example, one password for the regular record and a second password for information the patient has pre-selected as being sensitive to them). When the patient has been authenticated and permission granted, the patient will typically withdraw the card.

A second key and password are normally required by a provider to enter the system/VPN. The provider (such as a physician) inserts their microchip identity card issued and authenticated by the network. A biometric marker such as a fingerprint may be requested as well. If the card's security number(s) and biometrics match the user ID and password pre-validated within the system, then the card is authenticated and access to the patient's record will be allowed, typically if the patient gives (or has otherwise given) consent. (The provider typically activates the system first so the patient can use the patient's card to give consent). The patient's identifier can be a larger-than-9-digit number preceded by a 4-digit insurance code. The physician's identifier can also be a larger-than-9-digit number preceded by a number (or other identifier) of the delivery system in which the physician is privileged. The physician may have several such identifiers on the physician provider card. If the insurance codes match, the physician has implicit permission to enter, modify, or delete information from the record stored on the patient medical record. If the codes do not match, then the patient's password can be given as consent to release medical information. In various embodiments, bio-metric markers (such as fingerprint, voice, retinal scan, and the like) can be used. If the biometric markers, the passwords and/or other pre-installed security codes match, the record can then be accessed.

Additional conditions can be placed on the transaction. For example, security levels can be selected by the patients which joining the system such that only parts of the record can be accessed (such as open access, a regular record or a sensitive record). Also, only that patient's record can be accessed. (In conventional systems, it may be possible to gain access to all of the records on an accessible server. In a smart card system normally only the record that passed all of the security requirements can be accessed.) When the physician withdraws the provider card, the session automatically ends without a cache (such as by flushing the cache) to return to that record (which is present in many conventional systems). This provides additional security, guards the patient's privacy and protects the physician from, for example, JACHO fines if they fail to log off the system and leave sensitive patient information on the computer for passersby to see.

Functional Interoperability: Field-to-field standardization among delivery systems or Clinical Information Systems has been difficult to achieve because of competing proprietary systems that prefer standardization only if they themselves are the standard. Haggling about standards has made field-to-field interoperability nearly impossible to achieve. DAS can resolve this problem. Delivery systems only have to agree to use the same security protocol to access their CIS. Provider smart cards can be used to log on to disparate CISs, wherever the patient's data resides and independent of the information system. The global portable medical record belongs to the patient (as compared to the institution) and when the patient gives permission only that patient's record for that session can be pulled up and accessed on that CIS. This can eliminate partisan bickering over field structure and allows records to be shared in any CIS in a read-only format to provide functional interoperability.

Functional interoperability provides a functional solution to data sharing at the point of care without having to come to universal agreement on all interoperability standards. A privileged provider (having a verified identity, being credentialed by a delivery system, and authenticated by the private network as an up-to-date valid subscriber) can access the server where the patient's full web record is stored to access that information. For example, the privileged provider can read from a record in Illinois and write orders in their own CIS in Oregon. A summary can be sent to the attending physician back home in Illinois. Records can thus be shared across delivery systems in real time providing continuity of care such that functional interoperability is achieved.

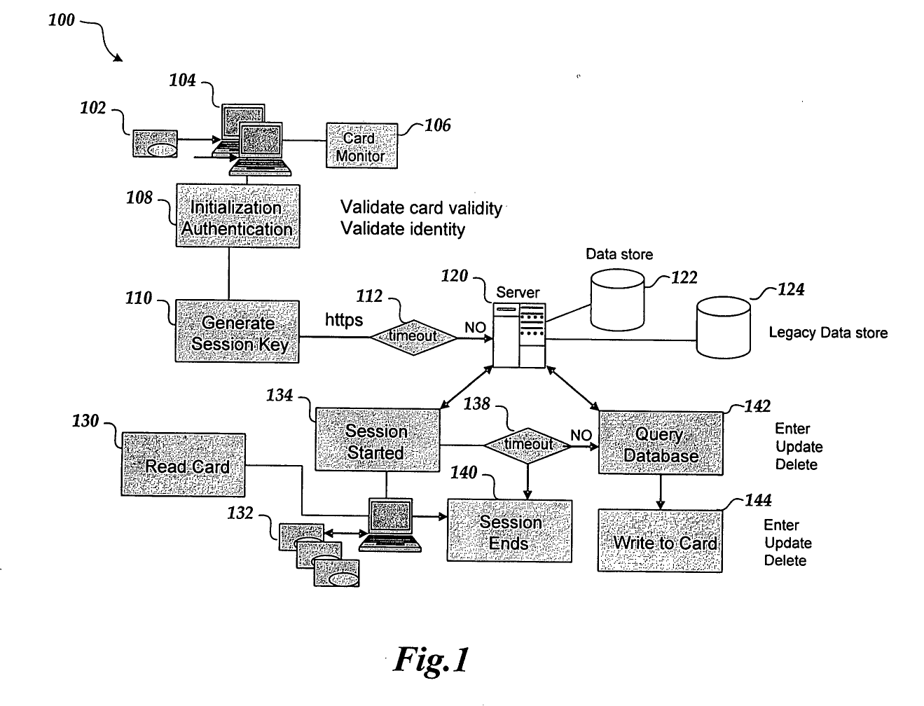

FIG. 1 is a logic diagram illustrating a dual access security system for medical records. System 100 comprises a smart card (such as a microchip card/CPU card or, for example, a memory card with or without processing capability). The smart cards can be a provider's card 102 and/or a patient's card 132. Patients would be issued smart card medical records 132 by their insurance company or by Medicare/Medicaid or a public health agency or other issuer. The issuer would normally provide identity data to guarantee the identity of the card holder.

Patients would use their card to gain access to system 100. At the first contact new subscribers would typically be asked a series of questions to complete their medical record (demographic, contact, and insurance information, allergies, problem list, past procedures & surgeries, devices, legal documents, living will, code status, growth and development, disabilities, vaccinations, list of medications, etc). The entry page can be web-based and filled out at home or at a kiosk (at the doctor's office, Public Health Service, library, and the like) that is connected to the system 100. A URL embedded within the card can be used to find the server, which was designated to store the entire record when it was issued and downloads that entry data to that server. The transfer can be through a Private Network accessed by a smart card that has been authenticated in the system and can be ultra-secure. If the public Internet is used then the transfer should be encrypted (by using a secure socket layer, for example) to ensure patient privacy.

The cards 132 function as portable medical records carrying core medical, legal, financial, insurance, and identity data. The insurance policy benefits can be stored on the card and used to adjudicate insurance directly from the card at the point of care. Pre-paid “money” stored on the cards can be used for co-payments or deductibles. Real access to the patient's data requires the physical possession of an authenticated patient card 132 and a matching valid password from the patient. It also requires the physical possession of a valid provider card 102 and authenticated by a biometric marker (such as a fingerprint, voice, retinal scan) and/or password stored in the system and encrypted on the card.

There can be, for example, three levels of security determined by individual preference stored on the card (1 open access, 2 regular record and 3 sensitive information). When the card is inserted into a reader, open access is available to the extent allowed by the patient. If the patient wants to protect sensitive information they will give the standard password and if they want the doctor to know about the sensitive information they can type in their second password allowing access to this data. This gives added HIPAA protection for the patient and the patient controls both access and content as originally intended by Congress.

The smart card readers at stations 104 and 136 perform a security check to guarantee the card's authenticity. The network can sort out counterfeits using authentication procedures. The database (data store 122 and/or legacy data store 124) is the data authority and when accessed ON-line downloads the most recent changes to the smart card portable record. The information can be synchronized to update the cards or update the database. If the card is lost or stolen it can be re-issued from the database repository.

The data on the cards 132 can normally only be accessed by a “provider smart card” 102 issued by the system 100. So if a patient card is lost the only information available to a lay reader would be what was designated as open access (name phone number address to return the card. If the patient prefers, the entire record can be made available as open access.

Providers (such as RNs, MDs, pharmacists, and the like) can be issued a card by the delivery system where they work. The credentials of the card holder would be validated by the delivery system to guarantee the identity of the cardholder. The delivery system can credential each provider with the state board of medical examiners each year and the provider cards can facilitate the annual renewals.

Provider cards can be used to access disparate Clinical Information Systems (CIS) if they are connected to a common private network (such as a VPN) and have password permission from the patient. For example, if a Mr. Stewart, a patient of a Dr. Jones at the University of Washington gets sick while traveling in New York, a Dr. Peck at Cornell can get access to Mr. Stewart's electronic record back in Seattle by having the patient insert his card 132 and type in a password. If Cornell and U.W. are subscribers to the GPMR Private Network, then Dr. Peck can read the record stored in a Cerner-CIS (a first proprietary system) in Seattle even though he regularly uses a HBOC-CIS (a second proprietary system) at Cornell. This provides functional connectivity but not true field-to-field interoperability. This eliminates the need for interoperability standards and allows different CIS systems to effectively communicate with each other by only sharing security access. This protects proprietary CIS systems, while promoting universal access.

Server 120 provides a Clinical Operating System (COS) that can connect various stations to a common integrated record that operates in real time. The COS would provide true field-to-field interoperability, since the field structure would be the same for each delivery system that used it. The COS system can create a process for a “longitudinal record,” where each original episode of care is appended over time and across delivery systems into a single medical record. In a longitudinal record system “reconstruction” is not necessary. Fragmented care is avoided and continuity is promoted so that systematic errors can largely be avoided. For example, the fifth leading killer in the United States is adverse drug interactions, which can be largely avoided by having all concerned parties connected to the same pharmacy system and by having that system operate in real time.

The COS integrated software can automatically collect data from the usual care processes and automatically enter the collected data into a relational database for analyzing the outcomes from the natural variations in care among practitioners. The knowledge base generated from collecting this variation can be used to optimize care for entire populations. The outcome analysis can be used to create evidence-based protocols to then decrease the variation in care standardizing to the best outcomes. This process can reduce medical errors, optimize healthcare outcomes, save lives and substantially decrease the cost of healthcare.

In operation, system 100 in various embodiments permits authorized access to medical records stored via server 120. When a provider card 102 is inserted into a station 104 and authenticated (108), a session key is generated (110) by the card and sent to server 120 along with the cardholder's name, ID number, and access level. The server initializes a new session (134) and stores (122 and 124) this information for future use. This session information is retained even after the provider card is removed (106). Depending on the application, when the provider card is removed the application will either return to the login page or display an Insert Patient Card prompt. The session remains active until (at 140): the user logs out of station 136; the card timeout period of 15 (for example) minutes elapses (112); the server session timeout period (138) elapses; or the user closes the browser window

After a provider card 102 has been authenticated and removed, a patient card 132 can be inserted into station 136 and read (130). A provider's access level determines what information on the patient card 132 can be viewed. If the patient is a subscriber to the same insurance group to which the provider belongs, no additional consent (for example) is required for the provider to view (142) and modify (144) information. If the provider does not belong to the same insurance group the patient can be required to enter their password, which can act as legal consent to release medical information. To view information that the patient has tagged as sensitive, the patient can be required to enter their second password to give consent to access that information.

When the patient card 132 is removed, the patient record is closed, the application returns to the login page, and previously viewed pages are removed from the cache. The original session can remain active and a different patient card may be inserted and viewed without having to authenticate the provider card again.

Although the invention has been described herein by way of exemplary embodiments, variations in the structures and methods described herein may be made without departing from the spirit and scope of the invention. For example, the positioning and/or sizing of the various components may be varied. Individual components and arrangements of components may be substituted as known to the art (PDAs, cellphones, memory sticks, radiofrequency imbedded chips, and the like). Since many embodiments of the invention can be made without departing from the spirit and scope of the invention, the invention is not limited except as by the appended claims.

What is claimed is:

1. A security system for medical records, comprising:
A security mechanism that is configured to authenticate a consumer computer-readable media device comprising a first authentication mechanism and a memory for storing consumer information that comprises information from a consumer history, and to authenticate a provider computer-readable media device comprising a second authentication mechanism;
a data store for storing the consumer history; and
a server that, in response to successful authentication of the consumer and provider computer-readable media devices, grants to the provider access to the information stored in the consumer computer readable media and/or grant access to the consumer history stored in the data store.

2. The apparatus of claim 1, wherein the first and second authentication mechanism comprise keys issued by the security mechanism.

3. The apparatus of claim 1 wherein server transfers data from the data store to the consumer computer-readable media device.

4. The apparatus of claim 4, wherein the server stores an episode of medical care in the consumer history when the episode of medical care is provided to the consumer.

5. The apparatus of claim 1, wherein the consumer computer readable media device has levels of security for granting different levels of access to the consumer information.

6. The apparatus of claim 1, wherein the consumer computer-readable media stores a locator for accessing the server across a network.

7. The apparatus of claim 1, wherein the provider computer-readable media stores medical licensing information of the provider.

8. The apparatus of claim 1, wherein the consumer computer-readable media comprises a password for allowing direct access to the consumer information.

9. The apparatus of claim 1, wherein the consumer computer-readable media device comprises information for authorizing payment for services provided to the consumer.

10. The apparatus of claim 1, wherein the provider computer-readable media device comprises insurance information for billing third parties for services provided to the consumer by the provider.

11. The apparatus of claim 1, wherein the consumer computer-readable media comprises a biometric identifier for allowing direct access to the consumer information.

12. A method for securely accessing medical records, comprising:
authenticating a provider card and establishing a secure session with a server;
authenticating a first consumer card that stores consumer information that comprises episodes of a consumer history of a consumer;
accessing a data store that stores the consumer history only when the secure session is active; and
providing the accessed information to a terminal that is associated with the authenticated provider card.

13. The method of claim 12, further comprising closing the secure session and flushing caches associated with the consumer history.

14. The method of claim 12, further comprising authenticating a second consumer card when the secure session is still active.

15. The method of claim 12, wherein the data store is accessed using passwords for differing security levels that are associated with the consumer card.

16. The method of claim 15, wherein the data store can be accessed without using one of the passwords when the consumer card and the provider card are associated with the same insurance entity.

17. The method of claim 12, further comprising editing contents of the consumer card in response to the accessed data.

18. A system for securely accessing medical records, comprising:
means for authenticating a provider card and establishing a secure session with a server;
means for authenticating a first consumer card that stores consumer information that comprises episodes of a consumer history of a consumer;
means for accessing a data store that stores the consumer history only when the secure session is active; and
means for providing the accessed information to a terminal that is associated with the authenticated provider card;

19. The method of claim 20, further comprising means for ending the session upon expiry of a timeout process.

20. The method of claim 12, further comprising authenticating a second consumer card when the secure session is still active.
